(19) United States
(12) Patent Application Publication
(10) Pub. No.: US 2018/0042328 A1
(43) Pub. Date: Feb. 15, 2018

(54) Motorcycle Helmet System

(71) Applicant: Tremaine Pryor, Palm Bay, FL (US)

(72) Inventor: Tremaine Pryor, Palm Bay, FL (US)

(21) Appl. No.: 15/233,065

(22) Filed: Aug. 10, 2016

(51) Int. Cl. A42B 3/04; G02B 27/01; G09G 5/00; A42B 3/22; A42B 3/30

(52) U.S. Cl. CPC A42B 3/0433; A42B 3/222; A42B 3/30; G09G 5/006; G02B 27/0176; G02B 27/0172; G02B 2027/0156

(57) ABSTRACT

A motorcycle helmet system includes a vehicle that may be ridden. The vehicle has at least one gauge. A helmet is provided and the helmet may be worn. A shield is hingedly coupled to the helmet. The shield is comprised of a sunlight reactive material. Thus, the shield darkens when sunlight hits the shield. A display unit is coupled to the helmet and the display unit is visible when the helmet is worn. The display unit is in electrical communication with the vehicle. Thus, the display unit displays operational parameters of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to helmet devices and more particularly pertains to a new helmet device for providing a heads up display in a helmet.

### BRIEF SUMMARY OF THE INVENTION

An embodiment of the disclosure meets the needs presented above by generally comprising a vehicle that may be ridden. The vehicle has at least one gauge. A helmet is provided and the helmet may be worn. A shield is hingedly coupled to the helmet. The shield is comprised of a sunlight reactive material. Thus, the shield darkens when sunlight hits the shield. A display unit is coupled to the helmet and the display unit is visible when the helmet is worn. The display unit is in electrical communication with the vehicle. Thus, the display unit displays operational parameters of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a helmet of a motorcycle helmet system according to an embodiment of the disclosure.

FIG. 2 is a right side perspective view of a helmet of an embodiment of the disclosure.

FIG. 3 is a perspective view of a helmet and a display unit of an embodiment of the disclosure.

FIG. 4 is a back perspective phantom view of an embodiment of the disclosure.

FIG. 5 is a perspective in-use view of an embodiment of the disclosure.

FIG. 6 is a perspective view of an embodiment of the disclosure.

### DETAILED DESCRIPTION OF THE INVENTION

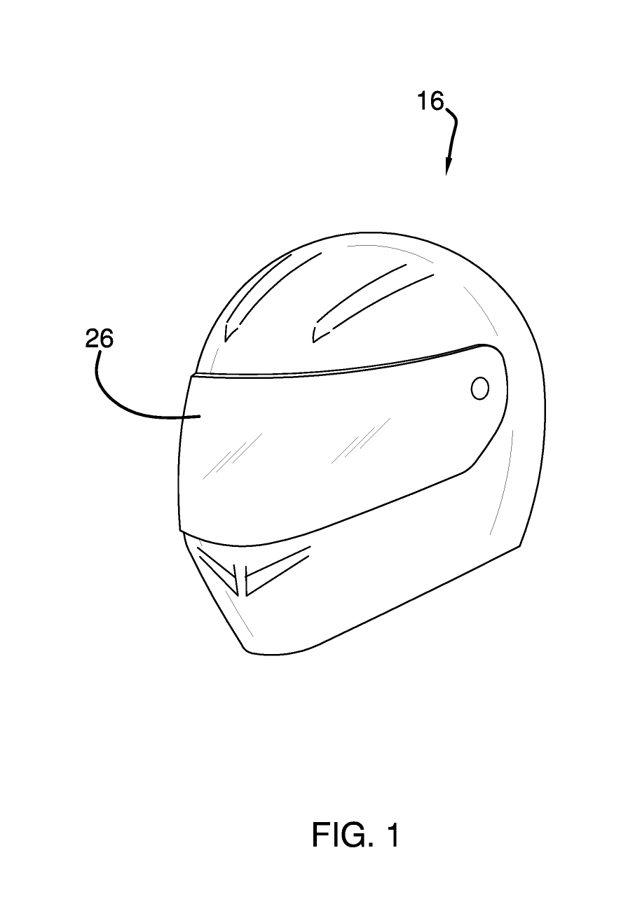

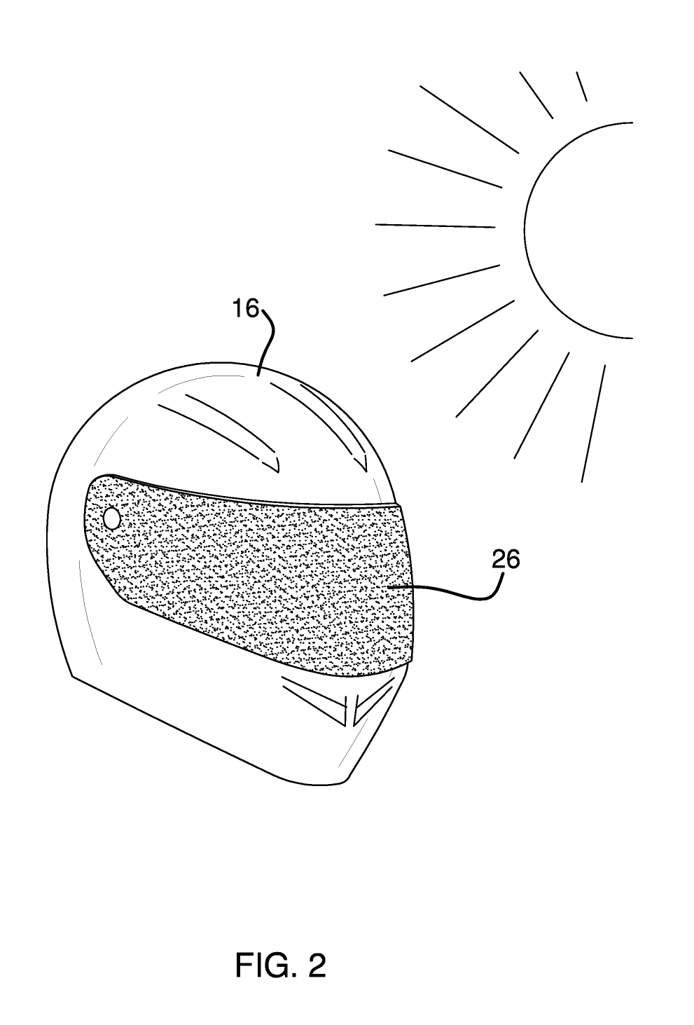

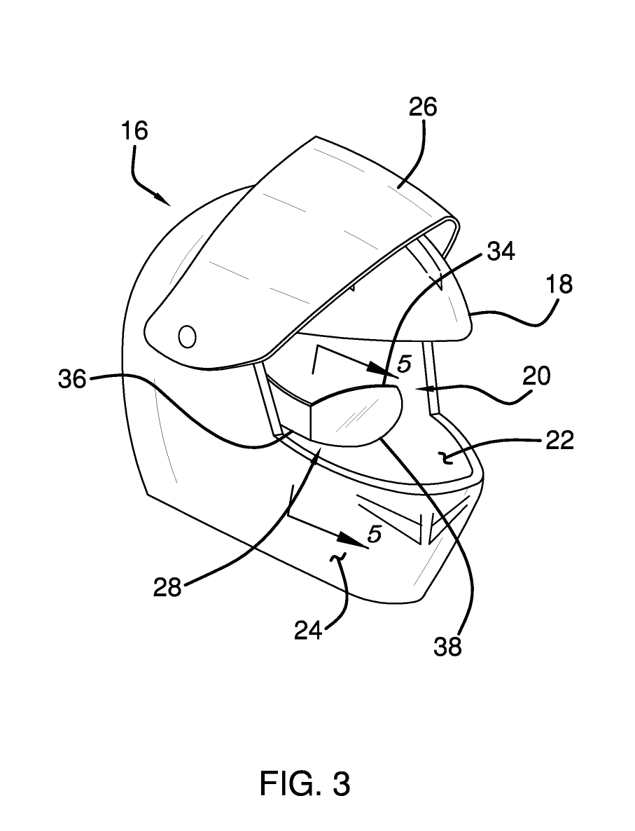

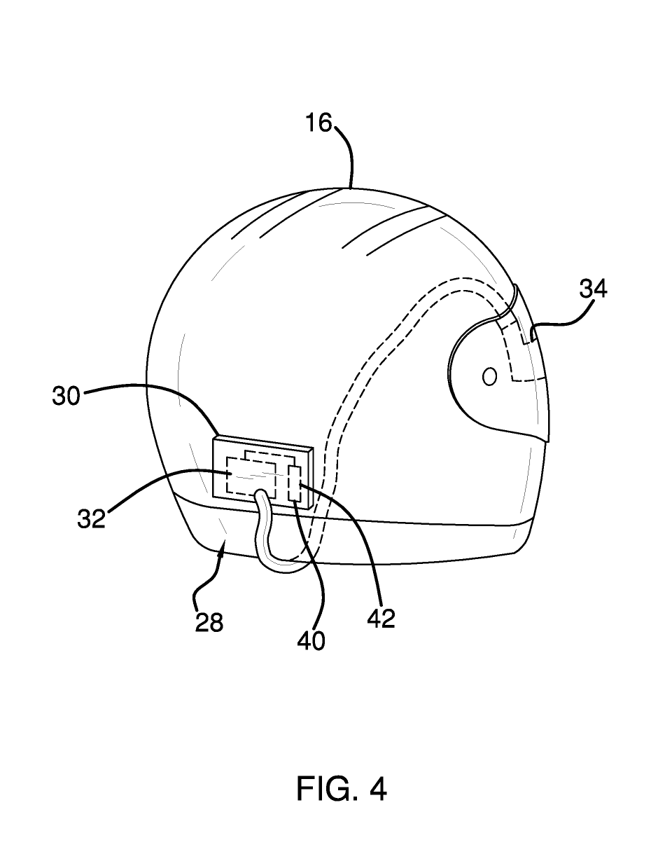

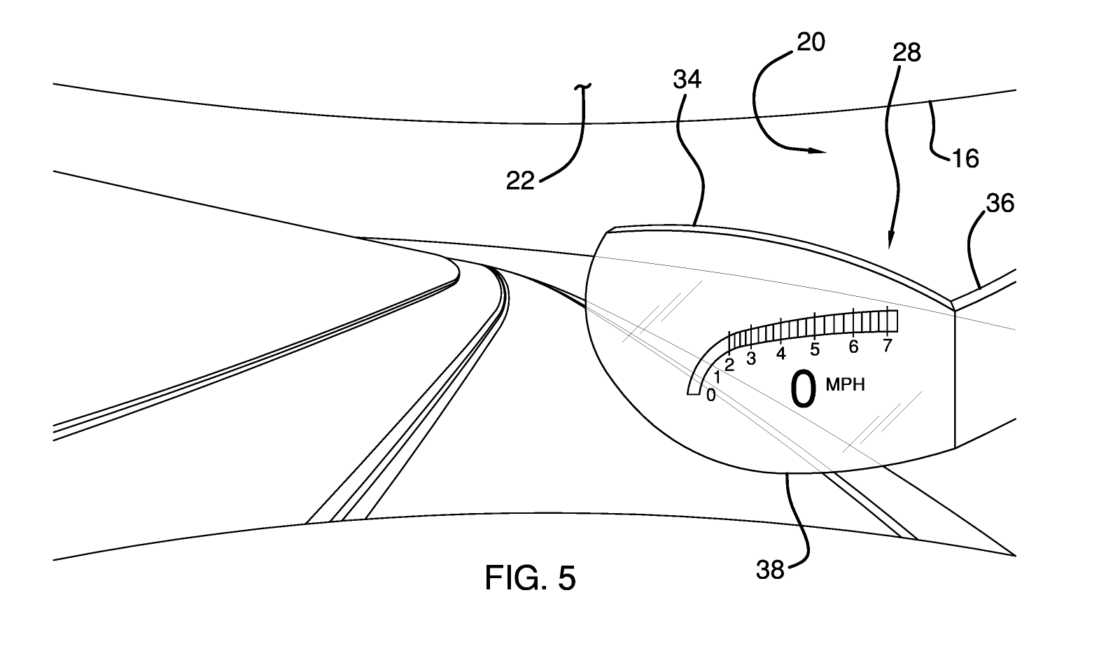

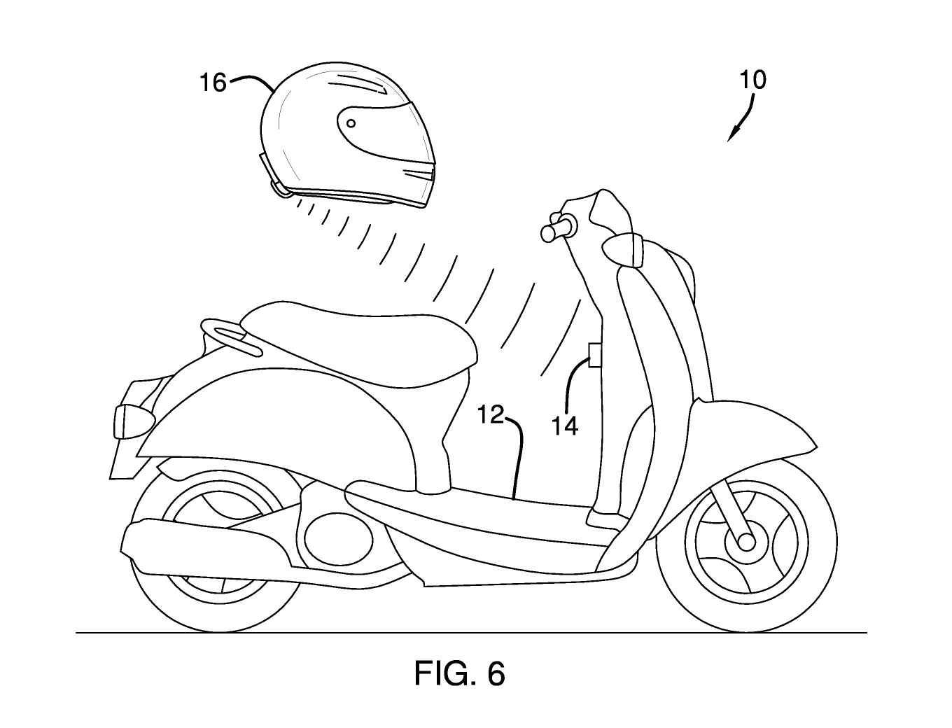

With reference now to the drawings, and in particular to FIGS. 1 through 6 thereof, a new helmet device embodying the principles and concepts of an embodiment of the disclosure and generally designated by the reference numeral 10 will be described.

As best illustrated in FIGS. 1 through 6, the motorcycle helmet system 10 generally comprises a vehicle 12 that may be ridden. The vehicle 12 has at least one gauge 14 and the vehicle 12 may be a motorcycle or the like. A helmet 16 is provided and the helmet 16 may be worn when the vehicle 12 is ridden. The helmet 16 has a forward side 18 and the forward side 18 has an opening 20 extending therethrough. Thus, the opening 20 is looked through when the helmet 16 is worn. The helmet 16 has an inner surface 22 and an outer surface 24. The helmet 16 may be a motorcycle helmet 16 of any conventional design.

A shield 26 is provided. The shield 26 is hingedly coupled to the helmet 16. The shield 26 is comprised of a sunlight reactive material. Thus, the shield 26 darkens when sunlight hits the shield 26. The shield 26 is selectively positioned to cover the opening 20 in the helmet 16. The shield 26 enhances a user's visibility when the user is riding the vehicle 12 into sunlight. Moreover, the shield 26 inhibits the user's face from being struck be debris, bugs and other objects.

A display unit 28 is provided. The display unit 28 is coupled to the helmet 16. The display unit 28 is visible when the helmet 16 is worn. The display unit 28 is in electrical communication with the vehicle 12. The display unit 28 displays operational parameters of the vehicle 12.

The display unit 28 comprises a housing 30 that is coupled to the outer surface 24 of the helmet 16. The housing 30 may be positioned on a rear side of the helmet 16. A processor 32 is positioned within the helmet 16. The processor 32 is in electrical communication with the at least on gauge 14. Thus, the processor 32 receives operational data from the at least on gauge 14.

The processor 32 may comprise an electronic processor or the like. The processor 32 may be electrically coupled to the at least on gauge 14 with a conductor or the like. A receiver may be provided and the receiver may be electrically coupled to the processor 32. The receiver may be in wireless electrical communication with the vehicle 12. Thus, the receiver may receive the operational parameters from the at least on gauge 14.

A heads up display 34 (hud) is provided. The hud 34 is coupled to the inner surface 22 of the helmet 16. The hud 34 may be an electronic heads up display or the like. The hud 34 is substantially aligned with the opening 20 in the helmet 16.

The hud 34 comprises a leg 36 and a foot 38. The leg 36 is coupled to the helmet 16. The foot 38 is coextensively aligned with the opening 20 in the helmet 16. Thus, the foot 38 is visible when the helmet 16 is worn. The foot 38 is comprised of a translucent material.

The hud 34 is electrically coupled to the processor 32. The hud 34 displays the operational parameters of the vehicle 12. Thus, the hud 34 facilitate the operational parameters to be observed without looking at the at least on gauge 14. The hud 34 enhances safety while operating the vehicle 12 by facilitating the user to keep the user's eyes on the road.

A power supply 40 is provided. The power supply 40 is positioned in the housing 30. The power supply 40 is electrically coupled to the processor 32. The power supply 40 comprises at least one battery 42.

In use, the helmet 16 is worn when the vehicle 12 is ridden. The processor 32 is electrically coupled to the vehicle 12. Thus, the processor 32 receives the operational data from the at least on gauge 14. The shield 26 is selectively positioned to cover the opening 20. The shield 26 darkens when the shield 26 is exposed to sunlight. The hud 34 displays the operational parameters of the vehicle 12. Thus, the operational parameters may be observed without looking at the at least one gauge 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorcycle helmet system comprising:
a vehicle being configured to be ridden, said vehicle having at least one gauge;
a helmet being configured to be worn;
a shield being hingedly coupled to said helmet, said shield being comprised of a sunlight reactive material wherein said shield is configured to darken when sunlight hits said shield; and
a display unit being coupled to said helmet wherein said display unit is configured to be visible when said helmet is worn, said display unit being in electrical communication with said vehicle such that said display unit displays operational parameters of said vehicle.

2. The system according to claim 1, wherein:
said helmet has an outer surface and an inner surface; and
said display unit comprises:
a housing being coupled to said outer surface of said helmet; and
a processor being positioned within said helmet, said processor being in electrical communication with said at least one gauge such that said processor receives operational data from said at least one gauge.

3. The system according to claim 3, further comprising:
said helmet having an opening: and
a heads up display (hud) being coupled to said inner surface of said helmet, said hud comprising a leg and a foot, said leg being coupled to said helmet having said foot being coextensively aligned with said opening in said helmet wherein said foot is configured to be visible when said helmet is worn, said foot being comprised of a translucent material, said hud being electrically coupled to said processor, said hud displaying said operational parameters wherein said hud is configured to facilitate the operational parameters to be observed without looking at said at least one gauge.

4. The system according to claim 2, further comprising a power supply being positioned in said housing, said power supply being electrically coupled to said processor, said power supply comprising at least one battery.

5. The system according to claim 1, wherein:
said helmet has a forward side, said forward side having an opening extending therethrough wherein said opening is configured to be looked through when said helmet is worn; and
said shield being selectively positioned to cover said opening in said helmet.

6. A motorcycle helmet system comprising:
a vehicle being configured to be ridden, said vehicle having at least one gauge;
a helmet being configured to be worn, said helmet having a forward side, said forward side having an opening extending therethrough wherein said opening is configured to be looked through when said helmet is worn, said helmet having an inner surface and an outer surface;
a shield being hingedly coupled to said helmet, said shield being comprised of a sunlight reactive material wherein said shield is configured to darken when sunlight hits said shield, said shield being selectively positioned to cover said opening in said helmet; and
a display unit being coupled to said helmet wherein said display unit is configured to be visible when said helmet is worn, said display unit being in electrical communication with said vehicle such that said display unit displays operational parameters of said vehicle, said display unit comprising:
a housing being coupled to said outer surface of said helmet;
a processor being positioned within said helmet, said processor being in electrical communication with said at least one gauge such that said processor receives operational data from said at least one gauge,
a heads up display (hud) being coupled to said inner surface of said helmet, said hud comprising a leg and a foot, said leg being coupled to said helmet having said foot being coextensively aligned with said opening in said helmet wherein said foot is configured to be visible when said helmet is worn, said foot being comprised of a translucent material, said hud being electrically coupled to said processor, said hud displaying said operational parameters wherein said hud is configured to facilitate the operational parameters to be observed without looking at said at least one gauge, and
a power supply being positioned in said housing, said power supply being electrically coupled to said processor, said power supply comprising at least one battery.
